(19) United States
(12) Patent Application Publication
(10) Pub. No.: US 2017/0004684 A1
(43) Pub. Date: Jan. 5, 2017

(54) ADAPTIVE AUDIO-ALERT EVENT NOTIFICATION

(71) Applicant: MOTOROLA MOBILITY LLC, Chicago, IL (US)

(72) Inventor: Matthew J. Slater, Champaign, IL (US)

(21) Appl. No.: 14/754,735

(22) Filed: Jun. 30, 2015

(51) Int. Cl. G08B 5/22; G08B 7/06

(52) U.S. Cl. CPC G08B 5/224; G08B 7/06

(57) ABSTRACT

An audio sample is collected. The collected audio sample is compared to a plurality of pre-existing unique audio-alert event signatures to identify one of the plurality of unique audio-alert event signatures matching the collected audio sample. An alert-notification message is communicated to an alert-notification device. The alert-notification message includes event-classification data associated with the identified unique audio-alert event signature.

### TECHNICAL FIELD

The disclosed subject matter relates generally to portable computing systems and, more particularly, to adaptive audio-alert event notification.

### BACKGROUND

Audio alerts are used in many applications to indicate an event to a user. For example many appliances (e.g., a washing machine, a dryer, an oven, a refrigerator) or other devices (e.g., a telephone, a doorbell) emit audio-alert signals when a cycle has completed, an alarm condition has been encountered, or a user's attention is required.

Propagation of these audio-alert signals in an indoor environment is problematic. The intended recipient of the audio-alert signal may be in another room, distracted by another activity or noise source, or possibly away from the environment completely. Thus, the audio-alert signal may be unheard and may not be addressed.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified block diagram of a communication system for detecting audio-alert events, according to some embodiments disclosed herein;

FIG. 2 is a flowchart of a method for detecting audio-alert events that may be implemented by the system of FIG. 1, according to some embodiments disclosed herein; and

FIG. 3 is a diagram of an illustrative audio-alert event signature library used by the system of FIG. 1, in accordance with some embodiments disclosed herein.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

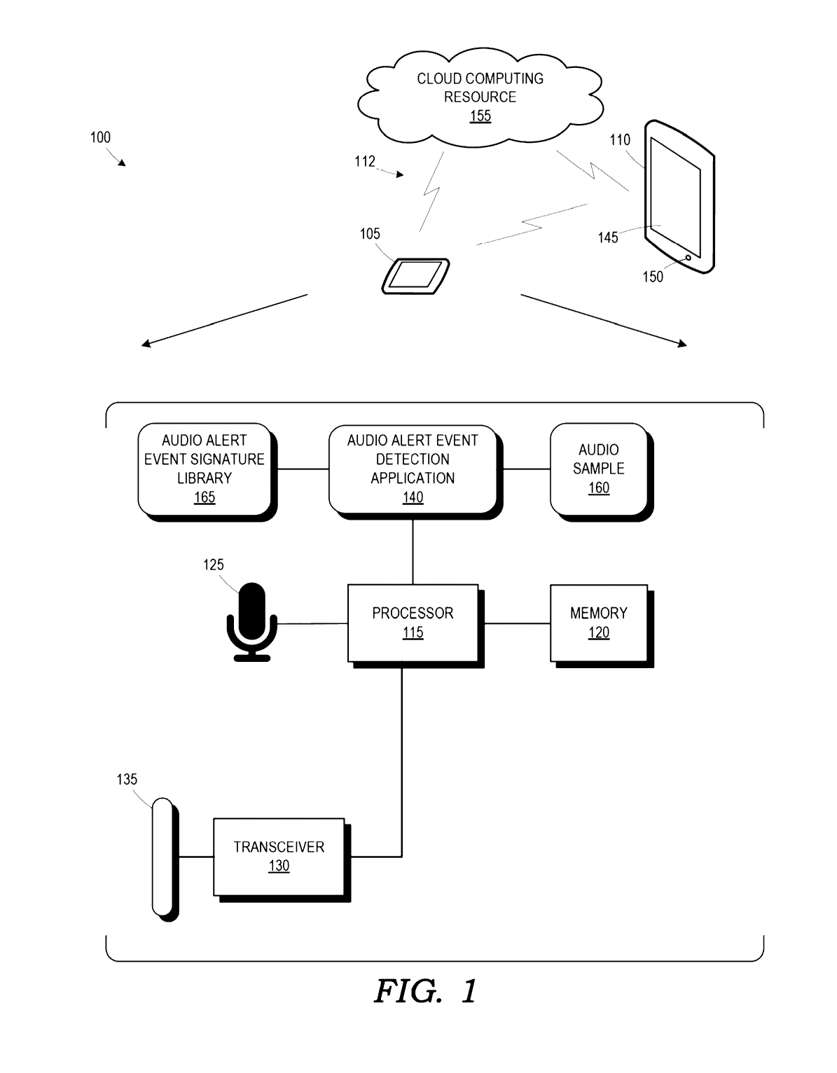

FIGS. 1 through 3 illustrate various examples of techniques for adaptively detecting and notifying a user of audio-alert events in accordance with aspects of the present subject matter. An audio sensor may be used to capture an audio sample which is compared to a library of audio-alert event signatures that are correlated to known audio-alert events. Upon detecting a known audio-alert event, an electronic alert notification is provided to a user. For example, an alert-detection device may send the electronic alert notification to the user's mobile phone, where a message may be provided to the user indicating the nature of the audio-alert event.

FIG. 1 is a simplistic block diagram of a communications system 100 including an alert-detection device 105 communicating with an alert-notification device 110 over a communication link 112. The alert-detection device 105 implements a computing system including, among other things, a processor 115, a memory 120, and a microphone 125. The memory 120 may be volatile or a non-volatile. The alert-detection device 105 includes a transceiver 130 for transmitting and receiving signals via an antenna 135 over the communication link 112. The transceiver 130 may include one or more radios for communicating according to different radio-access technologies, such as cellular, Wi-Fi, or Bluetooth®. In some embodiments, the alert-detection device 105 may be a special-purpose computing device, or it may be embodied in a general-purpose computing device, such as a desktop computer or a laptop computer. The communication link 112 may have a variety of forms. In some embodiments, the communication link 112 may be a wireless radio link between the devices 105 and 110. In other embodiments, the communication link 112 may be implemented over a communication network such as the Internet.

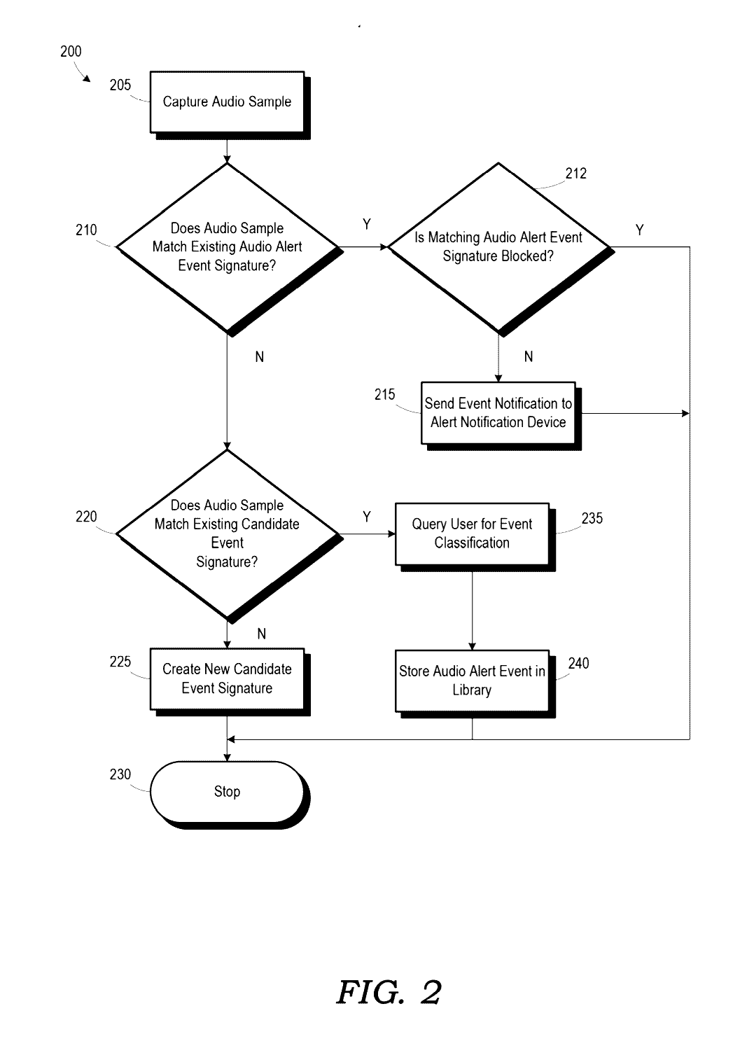

In the alert-detection device 105, the processor 115 may execute instructions stored in the memory 120 and store information in the memory 120, such as the results of the executed instructions. Some embodiments of the processor 115, the memory 120, and the microphone 125 may be configured to perform portions of the method 200 shown in FIG. 2 and discussed below. For example, the processor 115 may execute an audio-alert event detection application 140 to detect and identify audio-alert events and to communicate the alert events to the alert-notification device 110 over the communication link 112.

The alert-notification device 110 may also include a computing system having some or all of the entities in the computing system of the alert-detection device 105, such as a processor, a memory, and a transceiver. The alert-notification device 110 may also include a display 145 and a speaker 150 for relaying the detected audio-alert events to the user. In various embodiments, the alert-notification device 110 may be embodied in a handheld or a wearable device, such as a laptop computer, a handheld computer, a tablet computer, a mobile device, a telephone, a personal data assistant, a music player, a game device, a wearable computing device, and the like.

FIG. 2 is a flowchart of an illustrative method 200 for detecting and transmitting audio-alert events, in accordance with some embodiments. Various elements of the method 200 may be implemented on the alert-detection device 105 or on the alert-notification device 110. In some embodiments, a cloud-computing resource 155 (see FIG. 1) may also be used to perform one or more elements of the method 200.

In step 205, the alert-detection device 105 collects an audio sample 160 using the microphone 125. In some embodiments, the alert-detection device 105 may implement a threshold amplitude level for the audio sample 160 prior to processing with the method 200. For example, if an audio level in the audio sample 160 does not exceed the threshold, then the sample 160 is ignored. The alert-detection device 105 may listen until a particular sample or group of samples exceeds the threshold and then capture a predetermined time window of samples around the triggering sample for analysis. In some embodiments, a sliding time window may be employed for collection of the audio sample 160.

In step 210, the audio sample 160 is compared to a pre-existing library 165 (see FIG. 1) of audio-alert event signatures to determine if a match exists. Techniques for generating audio signatures and matching audio samples to the signatures in the library 165 are known to those of ordinary skill in the art, so they are not described in detail herein. For example, the comparison may be implemented in the time domain, the frequency domain, or some combination thereof.

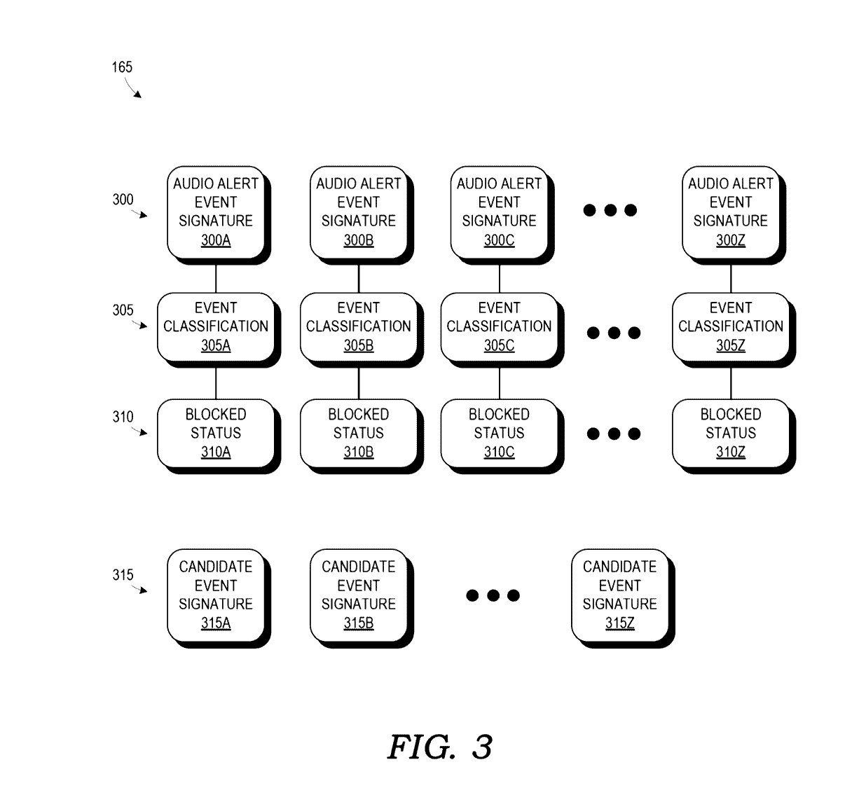

FIG. 3 is a simplified diagram of one embodiment of the library 165. The library 165 includes a plurality of unique audio-alert event signatures 300, individually denoted as event signatures 300A through 300Z. A unique event classification 305, individually denoted as event classifications 305A through 305Z, is associated with each audio-alert event signature 300. Audio-alerts events may be associated with alarms or signals generated by devices in the environment, such as an appliance end-of-cycle signal, a warning signal, a smoke or burglar alarm, or a doorbell. Audio-alerts events may also be associated with other sound patterns in the environment, such as a baby crying or a dog barking In some instances, the user may be in the area where the alert-detection device 105 is located but may not hear the initial audio alert. In other instances, the user may be away from the area.

If the collected audio sample 160 matches one of the existing unique audio-alert event signatures 300 in step 210, then it is determined if the matching audio-alert event signature has a status of blocked in step 212. A user may selectively block certain alerts based on preferences set in a blocked status identifier 310 (individually numbered 310A through 310Z), for example, to avoid certain alerts the user finds to be a nuisance. Event notifications for events having a status identifier of “blocked” are suppressed. If the matching audio-alert event signature is not blocked in step 212, then an event notification including the associated unique event classification 305 is sent to the alert-notification device 110 in step 215. For example, an application running on the alert-notification device 110 may receive the event notification from the alert-detection device 105 over the communication link 112. Responsive to receiving the unique event notification, the alert-notification device 110 may create a pop-up message for the user on the display 145 or generate an alert tone using the speaker 150 to inform the user of the occurrence of the unique event and of its classification. In some embodiments, the event notification may also include the collected audio sample 160 so that the user may listen to the actual sound that was recorded to verify the accuracy of the matching.

If the collected audio sample 160 does not match an existing audio-alert event signature 300 in the library 165 in step 210, then it may represent a new audio alert in the environment. To avoid detecting an excessive number of false audio-alert events, the alert-detection device 105 may wait until a particular audio signature is encountered a number of times prior to querying the user whether a new event has been detected. To facilitate this approach, the library 165 may include a plurality of unique candidate event signatures 315, individually denoted as candidate event signatures 315A through 315Z, representing unique audio patterns that have been identified in the environment but not yet classified (see FIG. 3).

Responsive to the collected audio sample 160 not matching an existing audio-alert event signature 300 in step 210, the audio sample 160 is compared to the unique candidate event signatures 315 in step 220. If no matching unique candidate event signatures 315 are identified in step 220, then a new candidate event signature 315 is created in step 225, and the method terminates in step 230. If an existing candidate event signature 315 is identified in step 220, then the user is queried for an event classification in step 235. In some embodiments, a counter may be associated with each of the candidate event signatures 315 so that the user may be queried only after the candidate signature has been matched a predetermined number of times. Querying the user may include sending the collected audio sample 160 to the alert-notification device 110, creating a pop-up message for the user that allows him to listen to the collected audio sample 160, and asking the user if the collected audio sample 160 warrants the creation of an associated new audio-alert event that should be subsequently tracked. If the user desires to track the event, then event-classification data may be provided by the user (e.g., “this is a doorbell”), and a new audio-alert event signature 300 may be stored in the library 165 in step 240. If the user determines that the collected audio sample 160 resulted in the generation of a false audio alert, then the associated candidate event signature 315 may be removed from the library 165 to reduce the likelihood of subsequent false alarms.

During an initializing or training period, the user may force the creation of audio-alert event signatures 300 by manually initiating the alert signal that is to be learned and by directing the audio-alert event detection application 140 to create the associated event. This training mode may be directed using an application executing on the alert-notification device 110. The alert-notification device 110 may send a signal to the alert-detection device 105 to collect the audio sample 160, during which the user initiates the audio alert to be learned. From the collected audio sample 160, the alert-detection device 105 may generate a new unique candidate event signature 315. The user may be directed to repeat the audio alert so that a subsequent audio sample 160 can be matched to the new candidate event signature 315 and classified as shown in FIG. 2. During this training mode, the repetition thresholds for candidate event signatures 315 may be suspended or modified.

In some embodiments, the cloud-computing resource 155 illustrated in FIG. 1 may perform some of the elements of the method 200 or may provide additional enhancements. For example, the size of the library 165 stored in the alert-detection device 105 may be limited. If a miss occurs in the library 165, then the alert-detection device 105 may send the audio sample 160 to the cloud-computing resource 155 so that it may be matched to a larger library of unique audio-alert event signatures. If the cloud-computing resource 155 identifies a matching unique audio-alert event signature, then it may be forwarded to the alert-detection device 105 for inclusion in the library 165. The user may be queried prior to adding the entry to the library 165 to validate the match. In such a situation, the match generated by the cloud-computing resource 155 may be handled like a candidate event signature 315 within the context of FIG. 2. For example, the forwarded audio-alert event signature may be stored in the library 165 as a new candidate event signature 300, and the user may be queried after the recurrence threshold is met. The cloud-computing resource 155 may also be used during the training period to facilitate the identification of matching audio-alert event signatures.

Alerting the user to detected audio-alert events allows immediate corrective actions to be taken to address the source of the audio alert. If the user is away from the premises, then the alert notification may communicate a need for the user to return. The detection of audio-alert events described herein may also be used to provide support for individuals with reduced hearing capabilities.

In some embodiments, certain aspects of the techniques described above may be implemented by one or more processors of a processing system executing software. The method 200 described herein may be implemented by executing software on a computing device, such as the processor 115 of FIG. 1. However, such methods are not abstract in that they improve the operation of the devices 105 and 110 and the user's experience when operating the devices 105 and 110. Prior to execution, the software instructions may be transferred from a non-transitory computer-readable storage medium to a memory, such as the memory 120 of FIG. 1.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method comprising:
collecting an audio sample;
comparing the collected audio sample to a plurality of pre-existing unique audio-alert event signatures to identify one of the plurality of unique audio-alert event signatures matching the collected audio sample; and
transmitting an alert-notification message to an alert-notification device, the alert-notification message including event-classification data associated with the identified unique audio-alert event signature.

2. The method of claim 1 further comprising:
responsive to determining that none of the plurality of unique audio-alert event signatures matches the collected audio sample, generating a new candidate event signature using the collected audio sample;
collecting a subsequent audio sample;
matching the collected subsequent audio sample to the new candidate event signature;
receiving event-classification data associated with the new candidate event signature; and
generating an audio-alert event signature based on the new candidate event signature and on the event-classification data associated with the new candidate event signature.

3. The method of claim 2 further comprising querying a user to provide the event-classification data.

4. The method of claim 2 wherein collecting the subsequent audio sample comprises collecting a plurality of subsequent audio samples, and the method further comprises:
maintaining a match counter associated with the new candidate event signature; and
receiving event-classification data associated with the new candidate event signature after the match counter indicates that the collected subsequent audio samples have been matched to the new candidate event signature a predetermined number of times.

5. The method of claim 1 wherein collecting the audio sample comprises collecting the audio sample using an alert-detection device, and transmitting the alert-notification message comprises sending the alert-notification message from the alert-detection device to the alert-notification device over a communication link.

6. The method of claim 1 wherein the plurality of unique audio-alert event signatures comprises a first library of unique audio-alert event signatures, and the method further comprises:
sending the collected audio sample to a remote computing device responsive to determining that none of the plurality of unique audio-alert event signatures in the first library matches the collected audio sample; and
receiving the event-classification data from the remote computing device.

7. A communications system comprising:
an alert-notification device; and
an alert-detection device configured to collect an audio sample, to compare the collected audio sample to a plurality of unique audio-alert event signatures to identify one of the plurality of unique audio-alert event signatures matching the collected audio sample, and to transmit the alert-notification message to the alert-notification device, the alert-notification message including event-classification data associated with the identified unique audio-alert event signature.

8. The system of claim 7 wherein the alert-notification device comprises a display and is configured to provide the event-classification data on the display.

9. The system of claim 8 wherein the alert-notification device comprises a mobile telephony device.

10. The system of claim 7 wherein the alert-detection device is configured to, responsive to determining that none of the plurality of unique audio-alert event signatures matches the collected audio sample, generate a new candidate event signature using the collected audio sample, to collect a subsequent audio sample, to match the collected subsequent audio sample to the new candidate event signature, to receive event-classification data associated with the new candidate event signature, and to generate an audio-alert event signature based on the new candidate event signature and on the event-classification data associated with the new candidate event signature.

11. The system of claim 10 wherein the alert-notification device is configured to query a user to provide the event-classification data responsive to a signal received from the alert-detection device.

12. The system of claim 10 wherein the alert-detection device is configured to capture a plurality of subsequent audio samples, to maintain a match counter associated with the candidate event signature, and to receive the event-classification data associated with the candidate event signature after the match counter indicates that the subsequent audio samples have been matched to the candidate event signature a predetermined number of times.

13. The system of claim 7 wherein the plurality of unique audio-alert event signatures comprises a first library of unique audio-alert event signatures, and wherein the alert-detection device is configured to send the collected audio sample to a remote computing device responsive to determining that none of the plurality of unique audio-alert event signatures in the first library matches the collected audio sample and to receive the event-classification data from the remote computing device.

14. A device comprising:
a memory;
a microphone configured to collect an audio sample; and
a processor configured to compare the collected audio sample to a plurality of unique audio-alert event signatures stored in the memory to identify one of the plurality of unique audio-alert event signatures matching the collected audio sample and to transmit an alert-notification message to a remote device, the alert-notification message including event-classification data associated with the identified unique audio-alert event signature.

15. The device of claim 14 wherein the processor is configured to, responsive to determining that none of the plurality of unique audio-alert event signatures matches the collected audio sample, generate a new candidate event signature using the collected audio sample, to receive a subsequently collected audio sample from the microphone, to match the subsequently collected audio sample to the new candidate event signature, to receive event-classification data associated with the new candidate event signature, and to generate an audio-alert event signature based on the new candidate event signature and on the event-classification data associated with the new candidate event signature.

16. The device of claim 15 wherein the processor is configured to collect a plurality of subsequent audio samples, to maintain a match counter associated with the new candidate event signature, and to receive the event-classification data associated with the new candidate event signature after the match counter indicates that the collected subsequent audio samples have been matched to the new candidate event signature a predetermined number of times.

17. The device of claim 14 wherein the plurality of unique audio-alert event signatures comprises a first library of unique audio-alert event signatures, and wherein the processor is configured to send the collected audio sample to a remote computing device responsive to determining that none of the plurality of unique audio-alert event signatures in the first library matches the collected audio sample and to receive the event-classification data from the remote computing device.
